(19) United States
(12) Patent Application Publication
(10) Pub. No.: US 2018/0168287 A1
(43) Pub. Date: Jun. 21, 2018

(54) SLIP-RESISTANT SHOELACE AND METHOD

(71) Applicant: Laura Ramirez-Chamberlin, Acworth, GA (US)

(72) Inventor: Laura Ramirez-Chamberlin, Acworth, GA (US)

(21) Appl. No.: 15/383,010

(22) Filed: Dec. 19, 2016

(51) Int. Cl. A43C 9/08; A43C 1/00; A43C 5/00; A43B 3/02; A43B 5/06; A43B 5/00; A43B 3/14; A41F 1/00; B05D 1/02; B05D 3/00; B05D 3/04; B05D 5/00; D06M 15/643

(52) U.S. Cl. CPC A43C 9/08; D06M 2101/06; A43C 5/00; A43B 3/02; A43B 5/06; A43B 5/002; A43B 3/14; A41F 1/00; B05D 1/02; B05D 3/007; B05D 3/0406; B05D 5/00; D06M 15/643; D06M 2200/00; A43C 1/00

(57) ABSTRACT

Slip-resistant laces for articles of dress, such as various types of footwear and clothing, and methods of making the same are provided. The slip-resistant laces include a first engagement portion and a second engagement portion. A silicone composition is applied to the first engagement portion and the second engagement portion by spraying the silicone composition from an aerosol can. A slip-resistant knot is formed by engaging the first engagement portion having the silicone composition with the second engagement portion having the silicone composition.

### BACKGROUND

### Field

This application relates to laces for footwear, and more particularly to slip-resistant laces and methods of making the same.

### Background Technology

Shoelaces are designed to slide holes or eyelets provided in footwear, such as shoes and sneakers. Depending on the preference of the wearer of the shoes, the shoelaces are tied loosely or tightly in various knots to provide a desired size and fitting of the shoe on the wearer's foot. When the shoelaces are tied, it is often desirable for the laces to stay tied as untied shoelaces may be annoying to the wearer and may create an unsafe condition. However, many laces fail to stay tied due to lace material, lace shape, movement or other forces acting on the laces during use, etc., requiring re-tying of the laces repeatedly throughout the day.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

In various embodiments, a method of reducing slippage of a lace of an article of dress includes providing the article of dress with the lace. In some embodiments, the lace is threaded through a plurality of openings defined by the article of dress. The method also includes extending a first end and a second end of the lace away from the article of dress such that the first end and the second end of the lace are spaced apart from the article of dress. A first engagement portion of the lace is defined along the lace between the article of dress and the first end. A second engagement portion of the lace is defined along the lace between the article of dress and the second end. In various embodiments, the first engagement portion is disengaged from the second engagement portion. In various embodiments, the method includes applying a silicone composition to the first engagement portion of the lace and applying the silicone composition the second engagement portion of the lace. The method further includes engaging the first engagement portion of the lace with the second engagement portion of the lace and forming a knot.

In some embodiments, applying the silicone composition includes spraying the silicone composition from an aerosol can and applying the silicone composition to the first engagement portion of the lace and the second engagement portion of the lace. In various embodiments, the article of dress includes footwear or garments.

Various implementations described in the present disclosure can include additional systems, methods, features, and advantages, which can not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a perspective view of a shoe with a shoelace untied.

FIG. 2 is a perspective view of a silicone composition being sprayed onto the shoelace of FIG. 1.

FIG. 3 is a perspective view of the shoelace of FIG. 2 with the silicone composition tied in a knot.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a band” can include two or more such bands unless the context indicates otherwise. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not. The word “or” as used herein means any one member of a particular list and includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements, and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment. Directional references such as “up,” “down,” “top,” “left,” “right,” “front,” “back,” and “corners,” among others are intended to refer to the orientation as illustrated and described in the figure (or figures) to which the components and directions are referencing.

Various implementations described in the present disclosure can include additional systems, methods, features, and advantages, which can not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

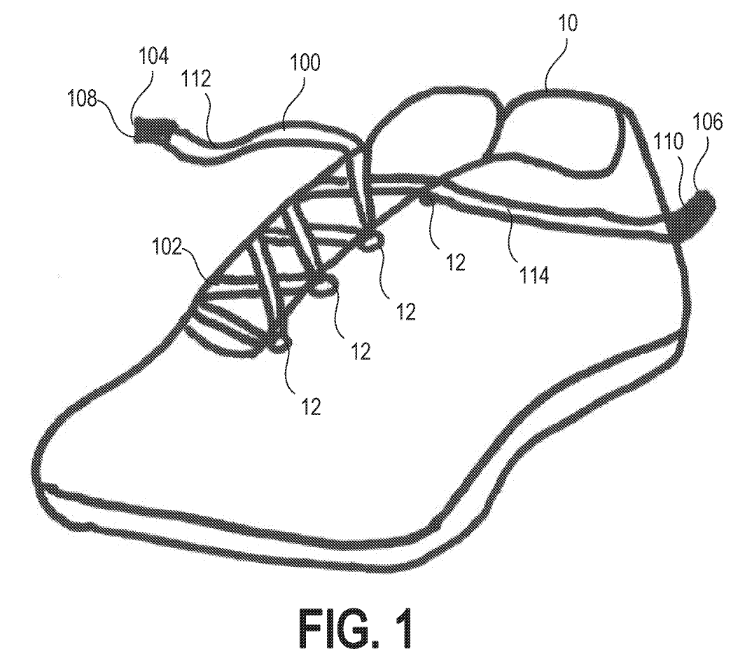

Referring to FIG. 1, in various examples, a shoe 10 may include lacing 100. The lacing 100 may be threaded through a plurality of openings 12 (such as eyelets, hoops, etc.) defined by the shoe 10. The number of openings 12 should not be considered limiting on the current disclosure. The lacing 100 may be tightened or loosened by a wearer of the shoe 10 to adjust the size and fit of the shoe 10 relative to the wearer's foot as desired, as well as allow for shoeing and unshoeing of the foot. The shoe 10 may be any type of footwear that utilizes lacing 100 to adjust the size and fit of the article of footwear. For example, in various embodiments, the article of footwear may be various types of footwear including, but not limited to sneakers, boots, dress shoes, running shoes, derby shoes, boat shoes, moccasins, cleats, climbing shoes, or various other types of footwear that utilize lacing 100. It will also be appreciated that the lacing 100 may be provided with various articles of dress other than footwear, such as garments, clothing, accessories, etc., that utilize lacing 100.

The lacing 100 includes a body 102 having a first end 104 and a second end 106. The body 102 may be constructed from various suitable materials such as various natural materials, synthetic materials, or combinations thereof. For example and without limitation, the body 102 may include cotton, textured polyester, spun polyester, nylon, polypropylene, leather, hemp, jute, or various other suitable materials. The body 102 defines a length extending from the first end 104 to the second end 106. In various embodiments, the length of the lacing 100 may depend on the type of lacing used or the number of openings 12, although it need not. In some cases, the length of the lacing 100 may be from about 45 cm. to about 200 cm., such as from about 65 cm. to about 180 cm. such as from about 75 cm. to about 150 cm., such as from about 100 cm. to about 130 cm., such as about 130 cm. In other examples, the length of the lacing 100 may be less than about 45 cm. or greater than about 200 cm. As illustrated in FIG. 1, in various examples, the first end 104 may include a first aglet 108 and the second end 106 may include a second aglet 110. In other examples, the first aglet 108, the second aglet 110, or both aglets 108 and 110 may be omitted.

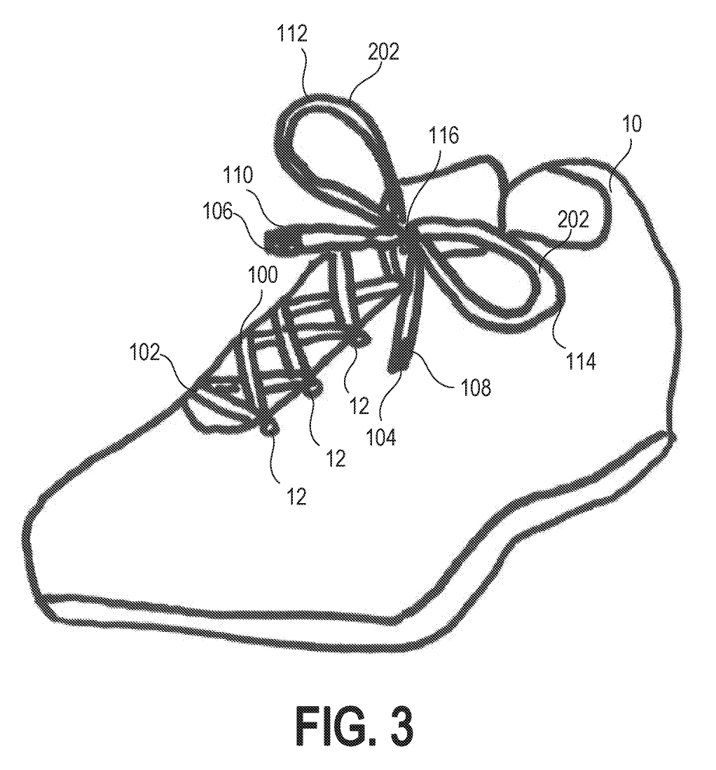

Referring to FIG. 1, the lacing 100 engaged with the shoe 10 (or other article of dress) defines a first engagement portion 112 between the first end 104 and the shoe 10. The lacing 100 defines a second engagement portion 114 between the second end 106 and the shoe 10. The first engagement portion 112 and the second engagement portion 114 are the portions of the lacing 100 that may be used to form a knot 116 (see FIG. 3), as described in detail below. In an untied configuration, as illustrated in FIG. 1, the first engagement portion 112 is disengaged from the second engagement portion 114.

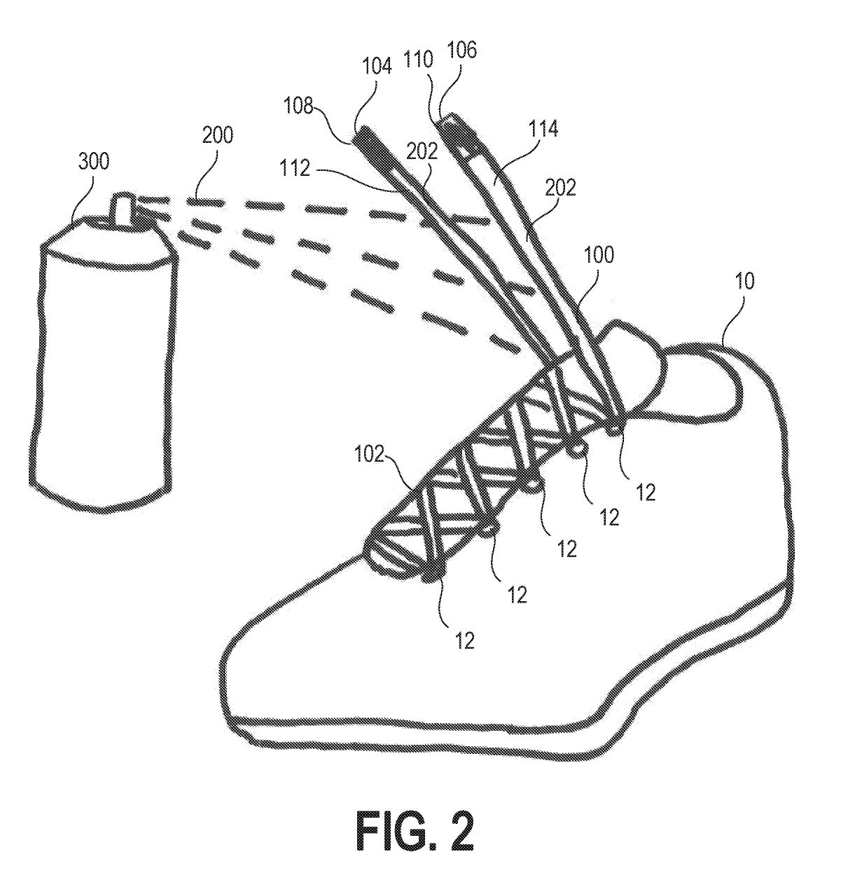

As illustrated in FIG. 2, a silicone composition 200 may be applied to the first engagement portion 112 and the second engagement portion 114 while the first engagement portion 112 is disengaged from the second engagement portion 114. In various embodiments, the silicone composition 200 is sprayed from an aerosol can 300. A silicone coating 202 is formed on the first engagement portion 112 and the second engagement portion 114. In various examples, the silicone coating 202 is optionally transparent such that the aesthetic appearance of the lacing 100 may be substantially unaltered by the silicone composition 200.

Referring to FIG. 3, in an engaged configuration, the first engagement portion 112 and the second engagement portion 114 may be in contact such that a desired tightness and configuration of the shoe 10 is maintained. In various examples, the first engagement portion 112 and the second engagement portion 114 form the knot 116. The knot 116 may be a bow knot, square knot, or various other types of knots. In shoes without the silicone coating on the first engagement portion 112 and the second engagement portion 114, the coefficient of friction between the engaged first and second engagement portions is relatively low. In the various embodiments, the silicone composition 200 on both the first engagement portion 112 and the second engagement portion 114 may have an increased coefficient of friction when engaged. The increased coefficient of friction maintains the integrity of the knot 116 as the silicone-coated first engagement portion 112 and second engagement portion 114 are less likely to slide, become adjusted, or come untied during use. In various embodiments, the portion of the body 102 of the lacing 100 between the first engagement portion 112 and the second engagement portion 114 is optionally uncoated with the silicone composition 200. In these embodiments, the uncoated portion of the body 102 may allow for easier sliding and movement of the lacing 100 through the openings 12 as the lacing 100 compared to movement of the silicone-coated portions of the body 102 through the openings 12.

Referring to FIGS. 1-3, a method of reducing slippage of the lacing 100 includes providing the shoe 10 (or other article of dress) with the lacing 100 threaded through the plurality of openings 12. As illustrated in FIG. 2, the method includes extending the first end 104 away from the shoe 10 such that the first end 104 is spaced apart from the shoe 10. In a similar manner, the second end 106 of the lacing 100 is extended away from the shoe 10 such that the second end 106 is spaced apart from the shoe 10. In various examples, the first end 104 and the second end 106 are extended away such that the first engagement portion 112 and the second engagement portion 114 are fully extended. For example, in some optional embodiments, extending the first end 104 and the second end 106 includes straightening the first engagement portion 112 and the second engagement portion 114 to reduce twisting and/or bending of the first engagement portion 112 and the second engagement portion 114.

Referring to FIG. 2, the method includes applying the silicone composition 200 to the first engagement portion 112 and the second engagement portion 114 while the first engagement portion 112 and the second engagement portion 114 are disengaged. Applying the silicone composition 200 may include spraying the silicone composition 200 from the aerosol can 300 to form the silicone coating 202 on the first engagement portion 112 and the second engagement portion 114.

In various embodiments, the method includes drying the silicone coating 202 on the first engagement portion 112 and the second engagement portion 114. In some cases, the silicone coating is dried at ambient temperatures and for a predetermined time period. In various embodiments, the predetermined time period is from about 10 minutes to about 2 hours, such as from about 30 minutes to about 1 hour, such as about 45 minutes. In other examples, the predetermined timer period may be less than 10 minutes or greater than 2 hours.

Referring to FIG. 3, the method includes engaging the silicone-coated first engagement portion 112 of the lacing 100 with the silicone-coated second engagement portion 114 of the lacing 100 and forming the knot 116. The engagement of the silicone-coated first engagement portion 112 of the lacing 100 with the silicone-coated second engagement portion 114 of the lacing 100 reduces and may prevent sliding, adjustment, or various other movements that may lead to untying of the knot 116 until the wearer of the shoe 10 unties the knot 116.

A collection of exemplary embodiments, including at least some explicitly enumerated as “ECs” (Example Combinations), providing additional description of a variety of embodiment types in accordance with the concepts described herein are provided below. These examples are not meant to be mutually exclusive, exhaustive, or restrictive; and the invention is not limited to these example embodiments but rather encompasses all possible modifications and variations within the scope of the issued claims and their equivalents.

EC 1. A method of reducing slippage of a lace of an article of footwear including: providing the article of footwear with the lace, wherein the lace is threaded through a plurality of openings defined by the article of footwear; extending a first end and a second end of the lace away from the article of footwear such that the first end and the second end of the lace are spaced apart from the article of footwear, wherein a first engagement portion of the lace is defined along the lace between the article of footwear and the first end, wherein a second engagement portion of the lace is defined along the lace between the article of footwear and the second end, and wherein the first engagement portion is disengaged from the second engagement portion; applying a silicone composition to the first engagement portion of the lace and applying the silicone composition the second engagement portion of the lace; and engaging the first engagement portion of the lace with the second engagement portion of the lace and forming a knot.

EC 2. A method of any preceding or subsequent example combination, wherein applying the silicone composition to the first engagement portion and applying the silicone composition to the second engagement portion includes spraying the silicone composition from an aerosol can onto the first engagement portion and onto the second engagement portion.

EC 3. The method of any preceding or subsequent example combination, further including drying the silicone composition on the first engagement portion and drying the silicone composition on the second engagement portion for a predetermined drying time.

EC 4. The method of any preceding or subsequent example combination, wherein the predetermined drying time is from about 10 minutes to about 2 hours.

EC 5. The method of any preceding or subsequent example combination, wherein the predetermined drying time is from about 30 minutes to about 1 hour.

EC 6. The method of any preceding or subsequent example combination, wherein forming the knot includes forming a bow knot.

EC 7. The method of any preceding or subsequent example combination, wherein the article of footwear includes at least one of a sneaker, a boot, a dress shoe, a running shoe, a derby shoe, a boat shoe, a moccasin, a cleat, or a climbing shoe.

EC 8. The method of any preceding or subsequent example combination, wherein the plurality of openings include a plurality of eyelets, and wherein the lace is threaded through the plurality of eyelets.

EC 9. The method of any preceding or subsequent example combination, wherein the silicone composition on the first engagement portion of the lace is transparent and wherein the silicone composition on the second engagement portion of the lace is transparent.

EC 10. The method of any preceding or subsequent example combination, wherein the lace includes a natural material, and wherein the natural material includes at least one of leather, hemp, cotton, or jute.

EC 11. The method of any preceding or subsequent example combination, wherein the lace includes a synthetic material, and wherein the synthetic material includes at least one of nylon, textured polyester, spun polyester, or polypropylene.

EC 12. The method of any preceding or subsequent example combination, wherein the first end of the lace includes an aglet and wherein the second end of the lace includes an aglet.

EC 13. The method of any preceding or subsequent example combination, wherein the lace includes a length of from about 45 cm. to about 200 cm.

EC 14. A method of reducing slippage of a lace of an article of footwear including: providing the article of footwear with the lace, wherein the lace is threaded through a plurality of openings defined by the article of footwear; extending a first end and a second end of the lace away from the article of footwear such that the first end and the second end of the lace are spaced apart from the article of footwear, wherein a first engagement portion of the lace is defined along the lace between the article of footwear and the first end, wherein a second engagement portion of the lace is defined along the lace between the article of footwear and the second end, and wherein the first engagement portion is disengaged from the second engagement portion; spraying a silicone composition from an aerosol can and applying the silicone composition to the first engagement portion of the lace and the second engagement portion of the lace; and engaging the first engagement portion of the lace with the second engagement portion of the lace and forming a knot.

EC 15. The method of any preceding or subsequent example combination, further including drying the silicone composition on the first engagement portion and drying the silicone composition on the second engagement portion for a predetermined drying time.

EC 16. The method of any preceding or subsequent example combination, wherein the predetermined drying time is from about 10 minutes to about 2 hours.

EC 17. The method of any preceding or subsequent example combination, wherein the predetermined drying time is from about 30 minutes to about 1 hour.

EC 18. A method of reducing slippage of a lace of an article of dress including: providing the article of dress with the lace, wherein the lace is threaded through a plurality of openings defined by the article of dress; extending a first end and a second end of the lace away from the article of dress such that the first end and the second end of the lace are spaced apart from the article of dress, wherein a first engagement portion of the lace is defined along the lace between the article of dress and the first end, wherein a second engagement portion of the lace is defined along the lace between the article of dress and the second end, and wherein the first engagement portion is disengaged from the second engagement portion; spraying a silicone composition from an aerosol can and applying the silicone composition to the first engagement portion of the lace and the second engagement portion of the lace; and engaging the first engagement portion of the lace with the second engagement portion of the lace and forming a knot.

EC 19. The method of any preceding or subsequent example combination, wherein the article of dress includes footwear.

EC 20. The method of any preceding or subsequent example combination, wherein the article of dress includes clothing.

It should be emphasized that the above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims which follow, they are used only in a generic and descriptive sense, and not for the purposes of limiting the described invention, nor the claims which follow.

That which is claimed is:

1. A method of reducing slippage of a lace of an article of footwear including:
providing the article of footwear with the lace, wherein the lace is threaded through a plurality of openings defined by the article of footwear;
extending a first end and a second end of the lace away from the article of footwear such that the first end and the second end of the lace are spaced apart from the article of footwear, wherein a first engagement portion of the lace is defined along the lace between the article of footwear and the first end, wherein a second engagement portion of the lace is defined along the lace between the article of footwear and the second end, and wherein the first engagement portion is disengaged from the second engagement portion;
applying a silicone composition to the first engagement portion of the lace and applying the silicone composition the second engagement portion of the lace; and
engaging the first engagement portion of the lace with the second engagement portion of the lace and forming a knot.

2. The method of claim 1, wherein applying the silicone composition to the first engagement portion and applying the silicone composition to the second engagement portion includes spraying the silicone composition from an aerosol can onto the first engagement portion and onto the second engagement portion.

3. The method of claim 1, further including drying the silicone composition on the first engagement portion and drying the silicone composition on the second engagement portion for a predetermined drying time.

4. The method of claim 3, wherein the predetermined drying time is from about 10 minutes to about 2 hours.

5. The method of claim 4, wherein the predetermined drying time is from about 30 minutes to about 1 hour.

6. The method of claim 1, wherein forming the knot includes forming a bow knot.

7. The method of claim 1, wherein the article of footwear includes at least one of a sneaker, a boot, a dress shoe, a running shoe, a derby shoe, a boat shoe, a moccasin, a cleat, or a climbing shoe.

8. The method of claim 1, wherein the plurality of openings include a plurality of eyelets, and wherein the lace is threaded through the plurality of eyelets.

9. The method of claim 1, wherein the silicone composition on the first engagement portion of the lace is transparent and wherein the silicone composition on the second engagement portion of the lace is transparent.

10. The method of claim 1, wherein the lace includes a natural material, and wherein the natural material includes at least one of leather, hemp, cotton, or jute.

11. The method of claim 1, wherein the lace includes a synthetic material, and wherein the synthetic material includes at least one of nylon, textured polyester, spun polyester, or polypropylene.

12. The method of claim 1, wherein the first end of the lace includes an aglet and wherein the second end of the lace includes an aglet.

13. The method of claim 1, wherein the lace includes a length of from about 45 cm. to about 200 cm.

14. A method of reducing slippage of a lace of an article of footwear including:
providing the article of footwear with the lace, wherein the lace is threaded through a plurality of openings defined by the article of footwear;
extending a first end and a second end of the lace away from the article of footwear such that the first end and the second end of the lace are spaced apart from the article of footwear, wherein a first engagement portion of the lace is defined along the lace between the article of footwear and the first end, wherein a second engagement portion of the lace is defined along the lace between the article of footwear and the second end, and wherein the first engagement portion is disengaged from the second engagement portion;
spraying a silicone composition from an aerosol can and applying the silicone composition to the first engagement portion of the lace and the second engagement portion of the lace; and
engaging the first engagement portion of the lace with the second engagement portion of the lace and forming a knot.

15. The method of claim 14, further including drying the silicone composition on the first engagement portion and drying the silicone composition on the second engagement portion for a predetermined drying time.

16. The method of claim 15, wherein the predetermined drying time is from about 10 minutes to about 2 hours.

17. The method of claim 16, wherein the predetermined drying time is from about 30 minutes to about 1 hour.

18. A method of reducing slippage of a lace of an article of dress including:
providing the article of dress with the lace, wherein the lace is threaded through a plurality of openings defined by the article of dress;
extending a first end and a second end of the lace away from the article of dress such that the first end and the second end of the lace are spaced apart from the article of dress, wherein a first engagement portion of the lace is defined along the lace between the article of dress and the first end, wherein a second engagement portion of the lace is defined along the lace between the article of dress and the second end, and wherein the first engagement portion is disengaged from the second engagement portion;
spraying a silicone composition from an aerosol can and applying the silicone composition to the first engagement portion of the lace and the second engagement portion of the lace; and
engaging the first engagement portion of the lace with the second engagement portion of the lace and forming a knot.

19. The method of claim 18, wherein the article of dress includes footwear.

20. The method of claim 18, wherein the article of dress includes clothing.
